(19) United States
(12) Patent Application Publication
(10) Pub. No.: US 2010/0089472 A1
(43) Pub. Date: Apr. 15, 2010

(54) Faucet with Integral Filter and Method of Installation

(76) Inventors: Humberto V. Meza, Tustin, CA (US); Tony Barber, Anaheim, CA (US); Charles Flock, Carson, CA (US)

Correspondence Address: GREENBERG TRAURIG (PHX), INTELLECTUAL PROPERTY DEPARTMENT, 2450 COLORADO AVENUE , SUITE 400E, SANTA MONICA, CA, 90404, US

(21) Appl. No.: 12/263,172

(22) Filed: Oct. 31, 2008

Related U.S. Application Data
(60) Provisional application No. 61/001,189, filed on Oct. 31, 2007.

(51) Int. Cl. E03B 7/07; B01D 35/02; B01D 35/14

(52) U.S. Cl. 137/544; 210/136

(57) ABSTRACT

Embodiments of the disclosure provide a faucet with an integral filter for filtering fluid to be discharged from the faucet. A filter casing can house the filter cartridge and can be provided with an automatic shut-off valve actuable by the filter cartridge. The filter cartridge can include an integral check valve at its upstream end to prevent unwanted spillage of fluid from the filter cartridge when removed from the assembled position. A filter mount can selectively keep the faucet and the filter cartridge from being separated. A lock ring can be rotatable through an angle about a filter axis to selectively allow removal of the filter cartridge from the filter casing. The rotation of the lock ring can be through a small angle and the removal of the filter cartridge from the filter casing can be completed without rotation of the faucet, the filter cartridge, or the filter casing.

### RELATED APPLICATIONS

This application claims priority under 35 U.S.C. §119 to U.S. Provisional Patent Application No. 61/001,189 filed on Oct. 31, 2007, the entire contents of which is incorporated herein by reference.

### BACKGROUND

With growing concern about water quality, many individuals prefer not to drink tap water unless it is first filtered. There are a variety of different filtration systems including reverse osmosis systems, activated carbon filtration systems, distillation systems, and activated metal particle filtration systems. Some of these systems have a portion that sits on the user's countertop. Some of these systems attach directly to a user's water faucet, and some of these systems are located under the counter below a sink. In the case of under the counter filtration systems positioned below a sink surface, replacing the filter, which is recommended in many systems every three to six months, requires the user to go under the sink, typically remove many items from under the sink, remove a filter canister, and replace the filter. Since the workspace under a sink can be limited, it can sometimes be difficult to easily access a filter canister.

### SUMMARY

Embodiments of the disclosure provide a faucet with an integral filter for filtering fluid to be discharged from the faucet. A filter casing can house the filter cartridge and can be provided with an automatic shut-off valve actuable by the filter cartridge. The filter cartridge can include an integral check valve at its upstream end to prevent unwanted spillage of fluid from the filter cartridge when removed from the assembled position. A filter mount can selectively keep the faucet and the filter cartridge from being separated. A lock ring can be rotatable through an angle about a filter axis to selectively allow removal of the filter cartridge from the filter casing. The rotation of the lock ring can be through a small angle and the removal of the filter cartridge from the filter casing can be completed without rotation of the faucet, the filter cartridge, or the filter casing.

### DESCRIPTION OF THE DRAWINGS

FIG. 1 is a perspective view of a mounted filter assembly according to one embodiment of the invention.

FIG. 2 is a front view of the filter assembly of FIG. 1.

FIG. 3 is a top view of the filter assembly of FIG. 1.

FIG. 4 is a side view of the filter assembly of FIG. 1.

FIG. 5 is section view taken along line 5-5 of FIG. 4.

FIG. 6 is a first detail view of the view shown in FIG. 5.

FIG. 7 is a second detail view of the view shown in FIG. 5.

FIG. 8A is a perspective view of a portion of the mounted filter assembly illustrating a lock ring in a locked position.

FIG. 8B is a top view of a portion of the mounted filter assembly illustrating the lock ring in the locked position.

FIG. 9 is a perspective view of a portion of the mounted filter assembly illustrating the lock ring in the unlocked position.

FIG. 10 is a perspective view of the filter assembly removed from a mounting substrate.

FIG. 11 is a perspective view of a filter mount.

FIG. 12 is a perspective view of an alternate filter mount.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Reference to directions and general portions such as “up”, “down”, “upward”, “downward”, “top”, “bottom”, etc. refer to orientations and directions as illustrated in particular figures embodying the invention, as described. Different orientations and embodiments of the invention other than that illustrated and described may fall within the scope of the appended claims. The use of “upstream” and “downstream” refers to the intended flow of fluid through the filter assembly, as illustrated. Such an intended flow direction is made clear by the drawings and description contained herein, but does not unduly limit the scope of the invention, which is defined by the claims.

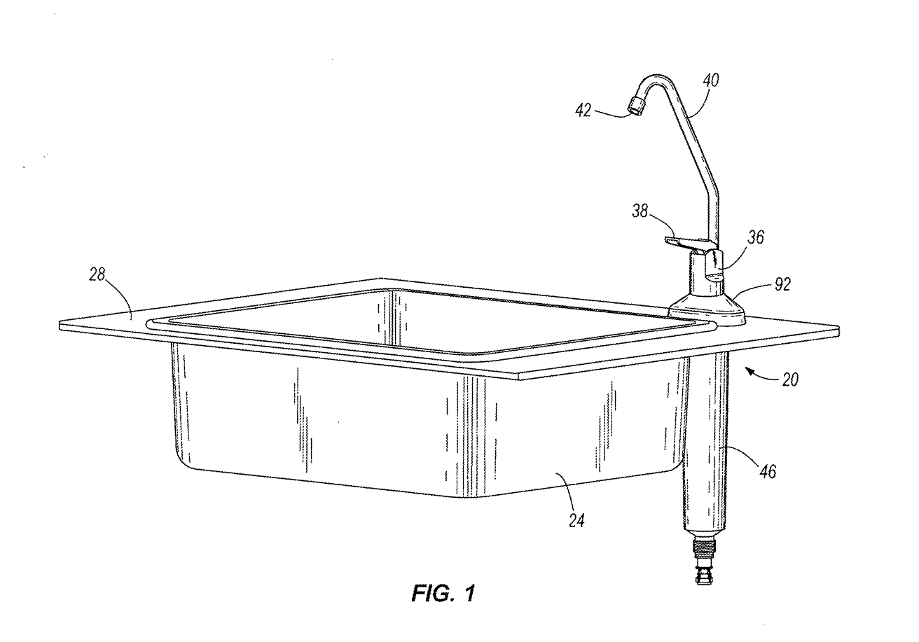

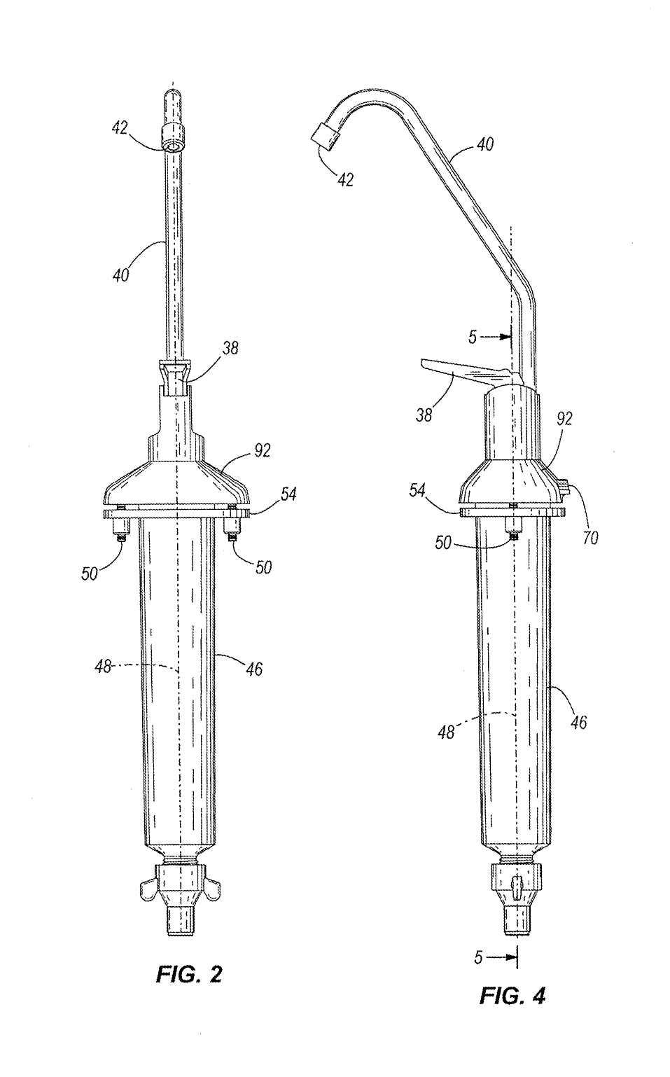

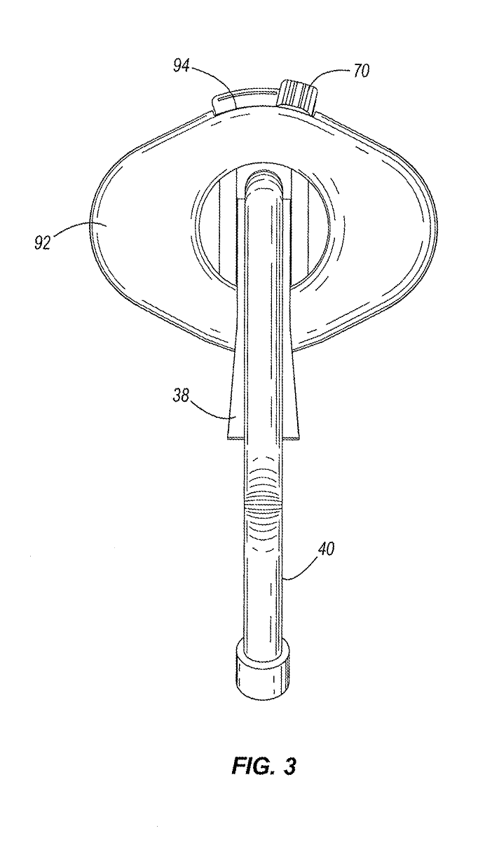

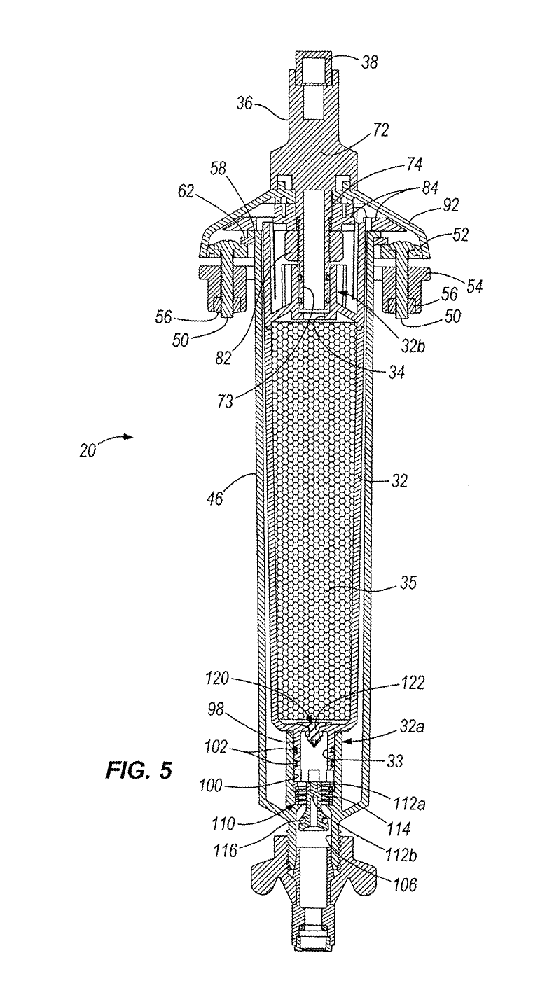

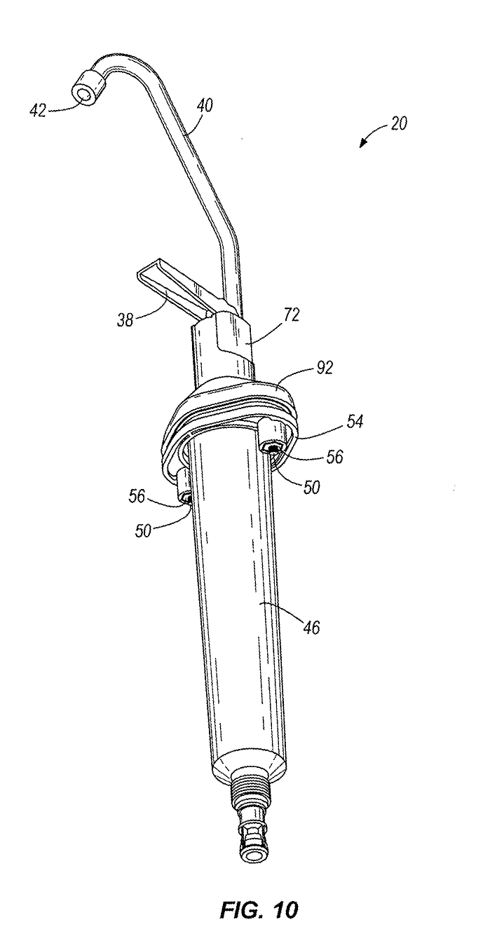

FIGS. 1-10 illustrate a filter assembly 20 according to one embodiment of the invention. The filter assembly 20 can be mountable to a mounting substrate such as a sink 24. The filter assembly 20 can be mounted to the sink 24 at an outward flange-like portion, or may alternately be mounted to a countertop 28, either directly or through a fitting, a mount, or an adapter. Various alternative applications can be suited for installation of the filter assembly 24. For example, the filter assembly 24 can be mounted to flat substrates or rounded substrates including concave and convex surfaces substrates, can be cantilever mounted with a bracket, and can even be self-supporting in some embodiments.

The filter assembly 20 can be a combination unit including a filter cartridge 32 and a fluid dispenser, such as a faucet 36. The faucet 36 can be a dispensing body suited for discharging a fluid. The faucet 36 as illustrated is one embodiment of a suitable fluid dispenser commonly used for discharging a fluid such as drinking water at a location adjacent the sink 24. The filter assembly 20 is not limited to use in filtering water for consumption, and is equally appropriate for use in all types of fluid handling systems including residential, commercial, scientific, etc.

The faucet 36 can include an actuator 38 in the form of a depressible handle. The actuator 38 can be operable in one or more directions from a rest position to open a dispensing valve (not shown) to discharge a fluid from an upstream fluid supply (not shown). The actuator 38 can be a handle, knob, or electro-mechanical sensor/actuator which can be actuable by an act of pushing, pulling, twisting, waiving of a hand in front of the sensor, among others. As shown in FIG. 1, the faucet 36 includes a long-necked spout 40 to accommodate filling large objects with fluid from the faucet 36 and/or to minimize the interference with additional faucets, the sink 24, etc. At the tip of the spout 40 is a faucet outlet 42 from which the fluid can be discharged from the filter assembly 20.

Upstream of the faucet 36 is the filter cartridge 32, which can be housed in a filter casing 46. The filter cartridge 32 can include a fluid inlet 33, a fluid outlet 34, and filtration media 35. The filtration media 35 can include media for altering one or more properties of fluid from the dirty side (upstream of the filtration media 35) to the clean side (downstream of the filtration media 35). The filter casing 46 can be substantially cylindrical and can define a filter axis 48, as shown in FIG. 1. In other embodiments, the filter casing 46 can be substantially non-cylindrical, such as rectangular, conical, trapezoidal, etc. while still defining the filter axis 48. The filter casing 46 can be mounted to the mounting substrate with two fasteners 50 through a flanged portion 52 of the filter casing 46. The fastening of the filter casing 46 can be accomplished in another manner, including, but not limited to, adhesive, welding, integral formation with a substrate, and alternate fasteners of various type and quantity. In some embodiments, the fasteners 50 are threaded and can be retained by a plate 54 underneath the substrate. In some embodiments, the plate 54 can be threaded to engage the fasteners 50, and in other embodiments, separate nuts 56 can be used.

The flanged portion 52 of the filter casing 46 can include a retaining groove 58 for holding a locking element such as a lock ring 62. The lock ring 62 can be retained by the retaining groove 58 against axial movement relative to the filter casing 46 along the filter axis 48. The retaining groove 58 can allow rotation of the lock ring 62 within the groove and substantially about the filter axis 48. The lock ring 62 can be generally round with a substantially flat cross-section. The lock ring 62 can include blocking tabs 66, which can be circumferentially-spaced around the lock ring 62 and can be radially inwardly protruding from the lock ring 62. The blocking tabs 66 can be used to lock the filter cartridge 32 in an assembled position within the filter casing 46. The lock ring 62 can also include an actuating tab 70, which can project radially outwardly from the lock ring 62. The actuating tab 70 can provide a location for a user to actuate the lock ring between the locked and unlocked positions.

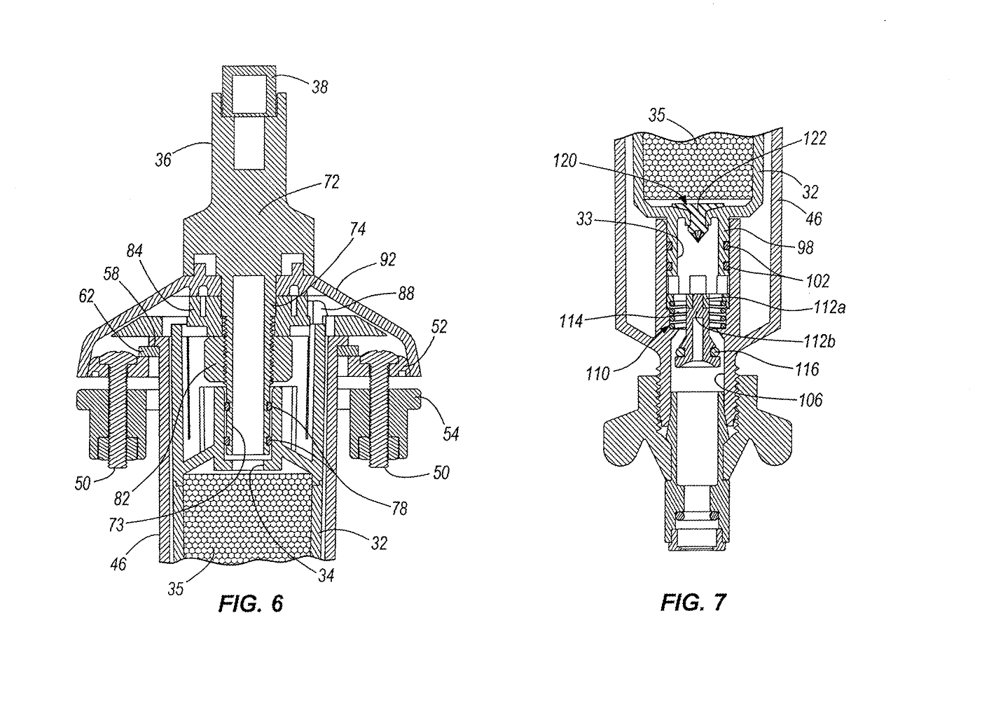

The faucet 36 can include a faucet body 72, which can include a faucet inlet 73 for receiving fluid from the filter cartridge 32. In some embodiments, the faucet inlet 73 can be directly coupled to and integrated with the filter cartridge 32. The faucet body 72 can house the dispensing valve (not shown) and can be attached to the filter cartridge 32. As shown in FIG. 6, the faucet body 72 includes a neck portion 74 that can extend toward the filter cartridge 32. The neck portion 74 can extend into a recess at the downstream end 32b of the filter cartridge 32. The neck portion 74 can be at least partially threaded, and can include o-rings 78 attached to an outer surface. By insertion or the neck portion 74 into the filter cartridge 32, a substantially sealed fluid path can be formed between the downstream end 32b of the filter cartridge 32 and the faucet 36. A nut 82 can be threaded onto the neck portion 74 between the filter cartridge 32 and a filter mount 84. The nut 82 can be substantially snug against an underside of the filter mount 84. This can keep the faucet 36 from being unintentionally separated from the filter mount 84. Likewise, the filter cartridge 32 can include barbed fingers 88 engageable with the filter mount 84 to keep the filter cartridge 32 from being unintentionally separated from the filter mount 84. Therefore, the faucet 36 and the filter cartridge 32 can be directly connected to one another for defining a flow path and can be held against separation from each other by the filter mount 84. The filter mount 84 additionally includes a plurality of flanges 85 for selective engagement with the lock ring 62.

A cover 92 can be placed between the filter mount 84 and the portion of the faucet body 72 just downstream of the neck portion 74 and can extend around the portion of the filter assembly 20 above the mounting substrate to substantially conceal the filter mount 84, the lock ring 62, the filter cartridge 32, and the filter casing 46. A bottom portion of the cover 92 can lie substantially flush with the flanged portion 52 of the filter casing 46 against the mounting substrate. The cover 92 can include an opening 94 to allow the actuating tab 70 to pass outwardly through the cover 92 to allow actuation by the user between the locked and unlocked positions without removal of the cover 92. In some embodiments, the opening 94 can extend around a portion of a circumference of the cover 92 through a relatively small angle about the filter axis 48.

As shown in FIG. 7, the filter cartridge 32 also includes an upstream end 32a. The filter cartridge 32 can include a neck portion 98, which can be inserted into a recess 100 formed within the filter casing 46. The neck portion 98 can include 0-rings 102 for creating a substantially sealed fluid flow path from a filter casing fluid inlet 106 to the upstream end 32a of the filter casing 32. A shut-off valve 110 can be positioned adjacent the filter casing fluid inlet 106 for opening/closing the fluid flow passage between the fluid inlet 106 and the filter cartridge 32. The shut-off valve 110 can be substantially automatic in some embodiments to go from a closed position to an open position when the filter cartridge 32 is inserted into the assembled position within the filter casing 46, in which the neck portion 98 of the filter cartridge 32 is inserted into the recess 100 of the filter casing 46. The neck portion 98 can actuate a first plunger element 112a downward against a biasing spring 114 to open the valve 110. A scaling element 116 (e.g., an o-ring) carried on a second plunger element 112b of the valve 110 can be separated from sealing contact with the filter casing 46. When the filter cartridge neck portion 98 is removed from the recess 100, the biasing spring 114 can bias the plunger elements 112a, 112b and the sealing element 116 upward such that the sealing element 116 creates a seal with the filter casing 46 to substantially stop flow of fluid.

The filter cartridge 32 can be provided with a check valve 120, which can be integrated with the filter cartridge 32 at the upstream end 32a, as shown in FIG. 7. The check valve 120 can include a diaphragm element 122, which can be forced open upon incident fluid pressure upstream of the check valve 120, resulting in a flow of fluid through the filter cartridge 32. When an insufficient positive fluid pressure differential exists across the check valve 120 the diaphragm element 122 can return to a closed position, substantially sealing fluid from flowing through the check valve. When a fluid pressure differential exists across the check valve 120 that is made up of a relatively higher fluid pressure within the filter cartridge 32 (such as the case when the fluid supply is disconnected and/or the filter cartridge is disconnected from the filter assembly 20 and fluid remains within the filter cartridge 32), the fluid within the filter cartridge 32 acts on the diaphragm element to retain the check valve 120 in the closed position.

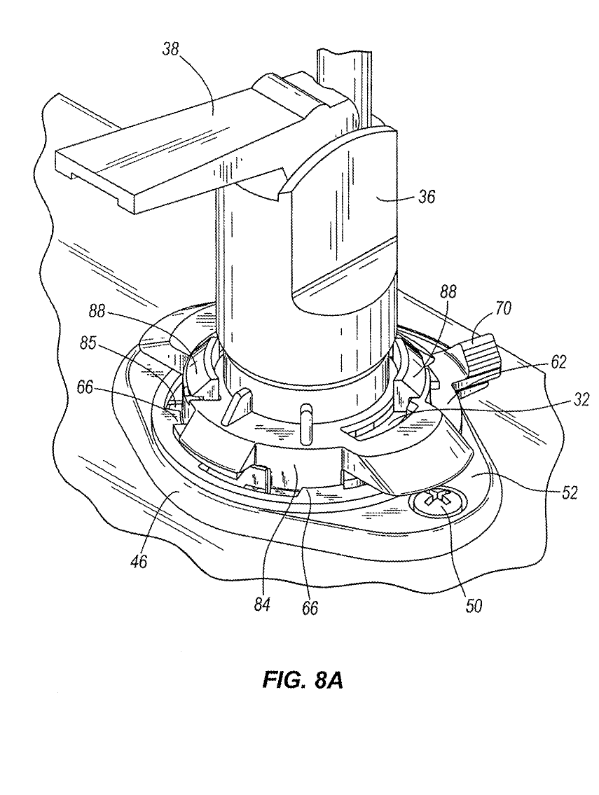

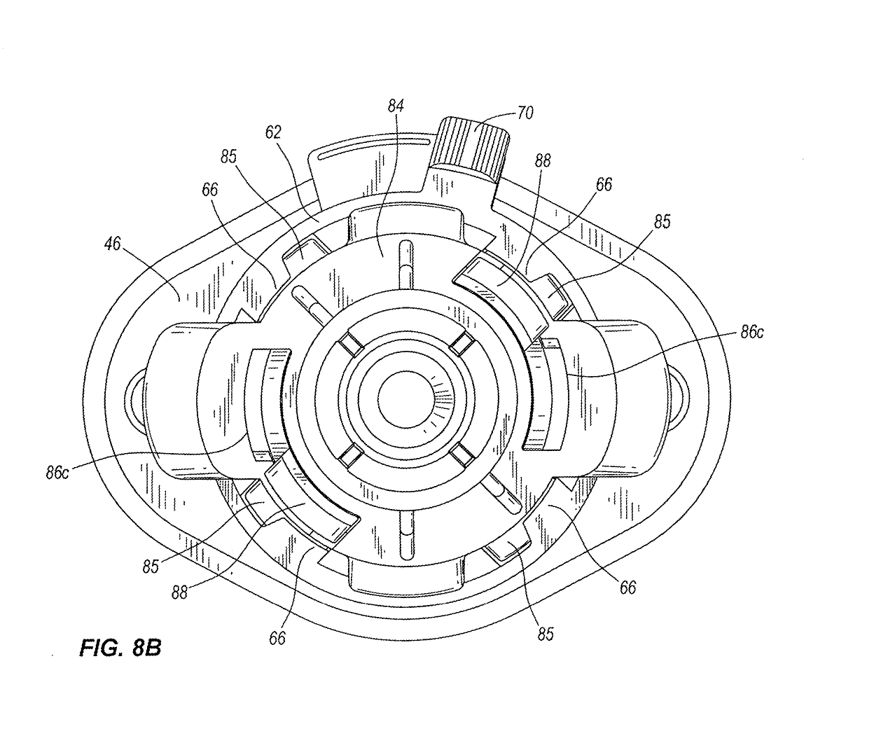

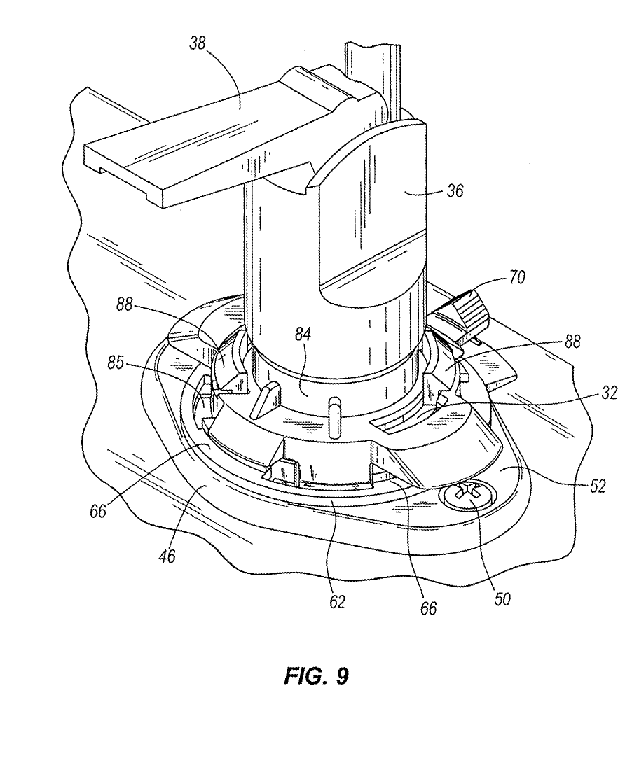

With particular reference to the remaining FIGS. 8A-12, the procedure is described in detail. In FIGS. 8A and 9, the cover 92 is not shown for clarity. In FIG. 8B, the faucet 36 and the cover 92 are not shown for clarity. The procedure for filter cartridge 32 removal and replacement is described with reference to the illustrated orientation, in which the faucet 36, filter cartridge 32, and filter casing 46 are mounted vertically to a flat mounting substrate. The procedure begins with an “in-use” filter assembly 20, in which the filter cartridge 32 is in the assembled position within the filter casing 46 and the lock ring 62 is in the locked position (shown in FIGS. 8A and 8B). The user may rotate the lock ring 62 from the locked position to the unlocked position (shown in FIG. 9) by using the actuating tab 70. By rotating the lock ring 62 from the locked to the unlocked position, the blocking tabs 66 can be rotated from positions that are circumferentially aligned with the flanges 85 of the filter mount 84 to positions that are clear from interference with the flanges 85. The unlocked position of the lock ring 62 can allow the filter cartridge 32 to be slid axially out of the filter casing 46, the flanges 85 passing adjacent to the respective blocking tabs 66 without being blocked by the blocking tabs 66. As illustrated in FIGS. 8A-9, the rotation of the lock ring 62 between the locked position and the unlocked position and vice versa can be through a relatively small angle about the filter axis 48. In some embodiments, the lock ring 62 can be actuated to/from the locked and unlocked positions through an angle of less than about 90 degrees about the filter axis 48. In some embodiments, the lock ring 62 can be actuated to/from the locked and unlocked positions through an angle of between about 15 degrees and about 40 degrees.

Because the filter assembly 20 is assembled with a filter mount 84, as described above and shown in FIG. 6, the user can grasp the faucet 36 and pull upwardly to remove both the faucet 36 and the filter cartridge 32 as an integrated unit from the assembled position. During removal of the faucet 36 and the filter cartridge 32, the shut-of valve 110 can be automatically actuated to the closed position such that fluid does not flow from the upstream fluid supply into the filter casing 46 or to adjacent locations where it is not useful or desired. Likewise, the change in fluid pressure differential adjacent the check valve 120 at the upstream end 32a of the filter cartridge 32 can cause the check valve 120 to become closed. This can substantially eliminate uncontrolled draining of fluid out of the filter cartridge 32 once separated from the filter casing 46. In the manner just described, the filter cartridge 32 can be removable from the filter casing 46 without substantial rotation of any components of the filter assembly 20 besides the lock ring 62, without first shutting off a valve or locking out the upstream fluid supply, and without unwanted spillage of fluid out of the filter assembly 20.

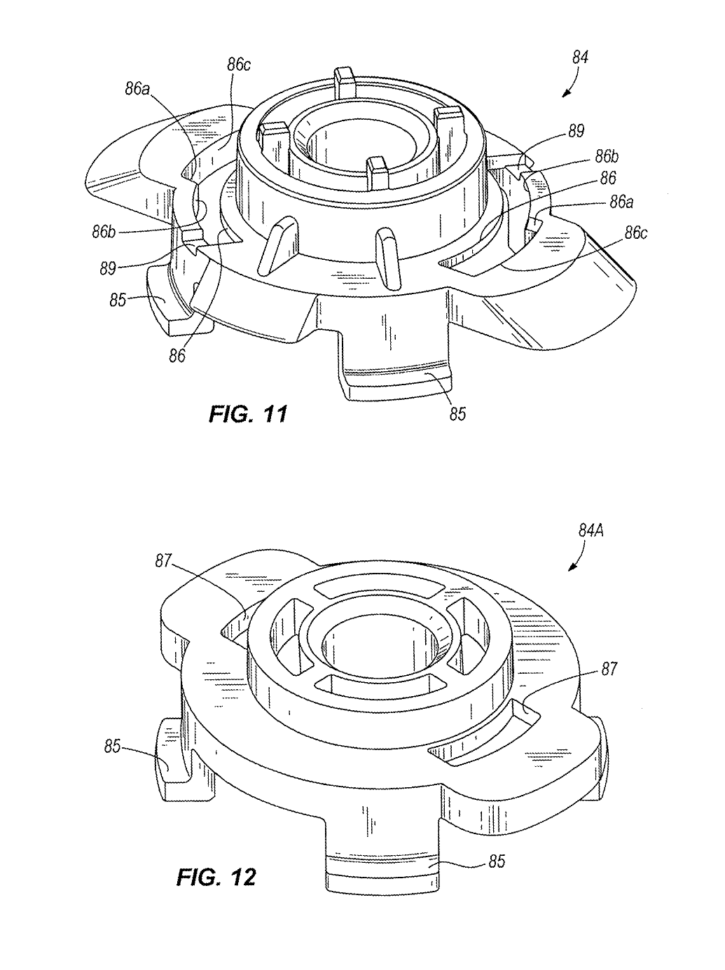

Once removed from the filter casing 46, an operator can separate the faucet 36 and the filter cartridge 32. In one embodiment, the filter cartridge 32 can be rotated relative to the faucet 36 to release the barbed fingers 88 of the filter cartridge 32 from engagement with the filter mount 84. The filter mount 84, as shown in FIG. 11 enables the filter cartridge 32 to be disengaged from the faucet 36 and the filter mount 84 by relative rotation. Openings 86 in the filter mount 84 can be formed with a step 86a to provide a change in the width of each opening 86, providing clearance for the barbed fingers 88 in one relative circumferential orientation and engaging the barbed fingers 88 in another relative circumferential orientation. Each opening 86 can form a circumferential slot allowing the barbed fingers 88 to be moved along the slots from the interference portion 86b (narrow width portion of opening 86) to the clearance portion 86c (large width portion of opening 86) or vice versa. From the assembled position, the filter cartridge 32 can be rotated relative to the filter mount 84 (clockwise as viewed in FIG. 8B) to put the barbed fingers 88 in the clearance portion 86c. The faucet 36 and the filter cartridge 32 can then be axially separated. The filter cartridge 32 is assembled with the faucet 36 and the filter mount 84 in a reverse manner, by inserting the barbed fingers 88 into the clearance portions 86c and rotating the filter cartridge 32 relative to the filter mount 84 (counter-clockwise as viewed in FIG. 8B). The filter mount 84 can include a detent 89 adjacent the interference portion 86b of each opening 86 for positively positioning the filter cartridge 32 relative to the filter mount 84 and faucet 36.

In another embodiment, the filter mount 84A (shown in FIG. 12) can allow disengagement of the filter cartridge 32 from the filter mount 84A (and thus the faucet 36) by pressing the barbed fingers 88 toward each other. In the assembled position, openings 87 in the filter mount 84A can retain the barbed fingers 88. The “squeezing” action of the barbed fingers 88 inward can remove the tips of the barbed fingers 88 from engagement with the filter mount 84A, allowing the barbed fingers 88 to be removed through the openings 87 as the faucet 36 and the filter cartridge 32 are axially separated from one another. Assembling the faucet 36 and filter cartridge 32 involves inserting the barbed fingers 88 into the openings 87 until the barbed fingers 88 “snap-in” the openings 87. The barbed fingers 88 can be squeezed together to aid insertion into the openings 87, but a deliberate squeezing force may not be required in some embodiments.

In other embodiments, a different locking mechanism can be used to attach/detach the faucet 36 and the filter cartridge 32 from each other, including some embodiments with more or fewer locking elements than the two barbed fingers 88 and some embodiments with locking elements shaped differently than the barbed fingers 88.

As discussed above, the filter cartridge 32 can be separated from the faucet 36 when the barbed fingers 88 are released from the filter mount 84, for example, by pulling the components away from each other. When separated, the filter cartridge 32 can be removed, discarded, and/or cleaned. The filter cartridge 32 can be reassembled with the faucet 36 and/or replaced by a similarly-formed “new” filter cartridge 32. The new filter cartridge 32 may vary in performance and contain alternate filter media, etc., but can include assembly components similarly-formed to the first filter cartridge 32 to enable direct replacement. The new filter cartridge 32 can be provided with barbed fingers 88 for assembly with the filter mount 84 or 84A in a manner similar to that described above.

When the filter cartridge 32 (new or old) is assembled with the faucet 36 and filer mount 84 or 84A, the assembly of the filter and faucet unit can be completed. The filter cartridge 32 can be inserted into the filter casing 46, which can open the shut-off valve 110. Once the filter cartridge 32 is in the assembled position, the lock ring 62 can be rotated about the filter axis 48 from the unlocked position (shown in FIG. 9) to the locked position (shown in FIGS. 8A and 8B).

The filter mount 84 or 84A can hold the faucet 36 and the filter cartridge 32 from separation from one another (unless expressly detached by the user by manipulating the barbed fingers 88). The faucet 36, particularly the neck portion 74, and the filter cartridge 32 can be directly coupled to one another at the filter mount 84 or 84A in the illustrated embodiment, and as such, the faucet 36 can be considered to be integral with the filter cartridge 32.

Herein and in the appended claims, reference to integration or the faucet 36 and the filter cartridge 32 being integral shall be taken to mean that the two form a unit, structurally. It should not necessarily be construed to mean that the faucet 36 and the filter cartridge 32 are formed from a single piece of material or are formed as an inseparable unit. In some embodiments, the filter cartridge 32 and faucet 36 can be formed separately and coupled to form a unit, rather than being remotely located from one another.

In the operations of filtering and dispensing fluid, the filter assembly 20 includes a “clean” side and a “dirty” side defined by the filter cartridge 32. Generally, the “dirty” side of the filter assembly 20 includes all flow passages upstream of the filtering media of the filter cartridge 32, and the “clean” side includes all flow passages downstream of the same.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. Various features and advantages of the invention are set forth in the following claims.

1. A combination filter and faucet mountable to a flat substrate and configured to receive a fluid from a fluid supply at an upstream end of a filter cartridge and discharge the fluid from a faucet outlet, the combination comprising:
a faucet body including the faucet outlet at a first end and a faucet inlet at a second end opposite the first end;
a filter casing substantially surrounding the filter cartridge and defining a filter axis; and
a lock ring rotatable about the filter axis to selectively lock the filter cartridge from displacement along the filter axis with respect to the filter casing.

2. The combination filter and faucet of claim 1, wherein the lock ring includes a plurality of circumferentially-spaced blocking tabs, each of which projects radially inwardly and the filter cartridge includes a plurality of circumferentially-spaced tabs, each of which projects radially outwardly from the filter cartridge.

3. The combination filter and faucet of claim 2, wherein the filter casing includes a flange mountable to the flat substrate, the flange having a retaining groove for receiving the lock ring to limit movement of the lock ring along the filter axis and allow rotation of the lock ring about the filter axis.

4. The combination filter and faucet of claim 3, wherein the lock ring includes an actuating tab projecting outwardly for rotary actuation of the lock ring between a locked position, in which the filter cartridge is not removable from the filter casing and an unlocked position, in which the filter cartridge is removable from the filter casing.

5. The combination filter and faucet of claim 4, wherein the plurality of blocking tabs of the lock ring are substantially aligned with the plurality of tabs of the filter cartridge in the locked position.

6. The combination filter and faucet of claim 4, further comprising a cover mountable over the flange of the filter casing and against an outer surface of the flat substrate to substantially conceal the filter casing and lock ring from view, the cover including an opening sized to allow the actuating tab of the lock ring to protrude therethrough and to allow rotation of the lock ring between the locked position and the unlocked position.

7. The combination filter and faucet of claim 1, wherein the filter cartridge includes an integral check valve at the upstream end of the filter cartridge to substantially limit fluid inside the filter cartridge from flowing out of the filter cartridge at the upstream end.

8. The combination filter and faucet of claim 1, wherein the filter casing includes a shut-off valve adjacent the upstream end of the filter cartridge that is biased in a closed position, substantially shutting off the fluid from flowing into the filter cartridge.

9. The combination filter and faucet of claim 8, wherein the shut-oil valve is movable to an open position by placement of the filter cartridge into the filter casing, the open position allowing, the fluid to flow from the fluid supply into the filter cartridge.

10. A filter assembly for use with an integral dispenser for filtering and dispensing a fluid, comprising:
a filter cartridge separating a clean side from a dirty side of the filter assembly;
a check valve within the filter cartridge, allowing flow of the fluid substantially exclusively from the dirty side to the clean side;
an automatic shut-off valve operable to go from an open state to a closed state automatically when the filter cartridge is removed from an assembled position within the filter assembly; and
a locking element for retaining the filter cartridge in the assembled position when in a locked state and allowing the filter cartridge to be lifted with the integral dispenser and separated from the filter assembly when in an unlocked state.

11. The filter assembly of claim 10, wherein the locked state and the unlocked state of the locking, element are separated by a rotation through an acute angle.

12. The filter assembly of claim 10, wherein the locking element is a lock ring including blocking tabs projecting radially inward for blocking the removal of the filter cartridge in the locked state.

13. The filter assembly of claim 12, further comprising a filter casing provided as a housing for the filter cartridge and being mounted to a substrate, the filter casing including a retaining groove for retaining the lock ring.

14. The filter assembly of claim 12, further comprising a cover for substantially concealing the lock ring and the filter cartridge from view, the cover having an opening for allowing an actuating tab of the lock ring to project therethrough.

15. The filter assembly of claim 10, wherein the integral dispenser is a faucet for selectively dispensing the fluid.

16. The filter assembly of claim 15, wherein the faucet is integrated with the filter cartridge via a filter mount such that the filter cartridge is removable as a unit with the faucet when the locking element is in the unlocked state.

17. A method of removing a filter cartridge with an attached faucet from a filter casing, the method comprising:
rotating a locking element about a filter axis through an angle of less than about 90 degrees from a locked state to an unlocked state;
grasping the faucet at a substantially exposed portion above a mounting substrate;
sliding the filter cartridge out of the filter casing; and
automatically shutting off a valve upstream of the filter cartridge when the filter cartridge is removed from the filter casing.

18. The method of claim 17, further comprising disconnecting the filter cartridge from the faucet by depressing at least one barbed finger integral with the filter cartridge.

19. The method of claim 17, wherein fluid within the filter cartridge remains within the filter cartridge and is substantially scaled from escaping an upstream end of the filter cartridge by a check valve integral with the filter cartridge.

20. The method of claim 17, wherein the removal of the filter cartridge from the filter casing does not require any substantial rotation of the filter cartridge, the Filter casing, or the faucet.

21. A filter cartridge for use in an integrated filter and faucet unit, the filter cartridge comprising:
an inlet for receiving fluid into the filter cartridge;
an outlet for directing fluid out of the Filter cartridge;
filtration media between the inlet and the outlet for filtering fluid passed therethrough; and
a locking element with a barbed finger for locking the filter cartridge with a faucet body and holding the integrated filter and faucet unit together.
